(19) United States
(12) Patent Application Publication
(10) Pub. No.: US 2019/0353935 A1
(43) Pub. Date: Nov. 21, 2019

(54) CONNECTING STRUCTURE CAPABLE OF CONNECTING VARIOUS EYEGLASSES AND ELECTRONIC DEVICES

(71) Applicant: Heng-Yu CHOU, Taipei City (TW)

(72) Inventor: Heng-Yu CHOU, Taipei City (TW)

(21) Appl. No.: 16/402,470

(22) Filed: May 3, 2019

(30) Foreign Application Priority Data
May 17, 2018 (TW) 107206416

(51) Int. Cl. G02C 11/00; G02C 5/14

(52) U.S. Cl. CPC G02C 11/10; G02C 5/146

(57) ABSTRACT

A connecting structure capable of connecting various eyeglasses and electronic devices includes a base disposed at a glasses leg of a pair of eyeglasses and a magnet installed at the base of the eyeglasses. The base has at least one embedded hole formed at the center of the base and configured to be corresponsive to the magnet; the bottom surface of the base has at least one protruding column adjacent to the embedded hole and corresponding to at least one through hole of the glasses leg, and the protruding column has a fastener fixed to the other side of the glasses leg and corresponding to the fixing portion of the fastener; the base has at least one electronic device attractable by the magnet. This structure can improve the convenience of use effectively.

### FIELD OF THE INVENTION

The present invention relates to the field of a connecting structure, more particularly to the connecting structure capable of connecting various eyeglasses and electronic devices, by designing a magnet at a base of a glasses leg of the eyeglass and/or using the base to connect at least one electronic device.

### BACKGROUND OF THE INVENTION

### 1. Description of the Related Art

Conventional electronic eyeglasses may need to fix an electronic device to the eyeglasses, or the electronic device cannot be combined with various different eyeglasses, so that the models of the eyeglasses are limited, the weight and cost of the eyeglasses are increased, and the aesthetic appearance, wearing comfort, and practical use of the eyeglasses are sacrificed. Obviously, the aforementioned bottlenecks await those skilled in the art and related consumers to break through.

### 2. Summary of the Invention

It is a primary objective of the present invention to overcome the drawbacks of the prior art by providing a connecting structure capable of connecting various eyeglasses and electronic devices by designing a magnet at a base of a glasses leg of the eyeglass and/or using the base to connect the electronic device.

Another objective of the present invention is to provide a connecting structure capable of connecting various eyeglasses and electronic devices by designing a magnet at the base of the glasses leg of the eyeglasses and provided for magnetically attracting any electronic device attractable by the magnet.

Another objective of the present invention is to provide a connecting structure capable of connecting various eyeglasses and electronic devices to improve the convenience of use effectively.

The present invention intends to overcome the problems of the conventional electronic eyeglasses that may need to fix an electronic device to the eyeglasses, or cannot combine the electronic device with various different eyeglasses, and finally lead to the limited models, increased weight and cost, and sacrificed aesthetic appearance, wearing comfort, and practical use of the eyeglasses.

To achieve the aforementioned objective, the present invention discloses a connecting structure capable of connecting various eyeglasses and electronic devices which is applied to a pair of eyeglasses having a glasses leg or at least one through hole formed on the glasses leg, or a pair of weldable eyeglasses, and comprises: a base, disposed at the glasses leg of the eyeglasses, and having a top surface and a bottom surface disposed at the upper end and the lower end of the base respectively; and a magnet, installed at the base, and having a top surface and a bottom surface disposed at the upper end and the lower end of the magnet respectively.

Wherein, the bottom surface of the base is substantially a plane and has an adhesive provided for adhering with the outer side of the glasses leg.

Wherein, the base has at least one embedded hole formed at the center of the base and configured to be corresponsive to the magnet.

Wherein, the embedded hole of the base is in an upwardly tapered conical shape or inverted T-shape.

Wherein, the bottom surface of the base has at least one protruding column disposed adjacent to the embedded hole and configured to be corresponsive to at least one through hole of the glasses leg, and the protruding column has a fastener fixed to the other side of the glasses leg.

Wherein, the base has a slot formed at the center of the base and configured to be corresponsive to the glasses leg of the eyeglasses, and the top surface of the base has a recess communicating to the slot.

Wherein, the magnet is in an upwardly tapered conical shape or inverted T-shape and configured to be corresponsive to the upwardly tapered conical shape or inverted T-shape embedded hole of the base.

Wherein, the bottom surface of the magnet is a plane and has an adhesive provided for adhering with the top surface of the base.

Wherein, the magnet is installed in the recess of the base and provided for sealing the glasses leg of the eyeglasses into the slot of the base.

Wherein, the base has at least one electronic device attractable by the magnet.

Compared with the prior art, the structure of the present invention uses a magnet installed at the base of the glasses leg of the eyeglasses and/or connecting at least one electronic device to the base to achieve the effect of connection, and the glasses leg of the eyeglasses and the magnet installed at the base are capable of attracting and attaching an electronic device attractable by the magnet. The invention improves the convenience of use and meets user requirements.

### BRIEF DESCRIPTION OF THE DRAWINGS

FIG. 1 is a first exploded view of the present invention;

FIG. 2 is a first cross-sectional view of the present invention;

FIG. 3 is a second exploded view of another embodiment of the present invention;

FIG. 4 is a second cross-sectional view of another embodiment of the present invention;

FIG. 5 is a third exploded view of a further embodiment of the present invention;

FIG. 6 is a third cross-sectional view of a further embodiment of the present invention;

FIG. 7 is a fourth exploded view of another further embodiment of the present invention;

FIG. 8 is a fourth cross-sectional view of another further embodiment of the present invention;

FIG. 9 is a fifth exploded view of a further embodiment of the present invention;

FIG. 10 is a fifth cross-sectional view of a further embodiment of the present invention;

FIG. 11 is a schematic view of the present invention as depicted in FIG. 1 combined with a glasses leg of a pair of eyeglasses;

FIG. 12 is a schematic view of the present invention as depicted in FIG. 3 combined with a glasses leg of a pair of eyeglasses;

FIG. 13 is a schematic view of the present invention as depicted in FIG. 7 combined with a glasses leg of a pair of eyeglasses;

FIG. 14 is a schematic view of the present invention as depicted in FIG. 11 having a base combined with an electronic device;

FIG. 15 is a schematic view of the present invention as depicted in FIG. 12 having a base combined with an electronic device;

FIG. 16 is a schematic view of the present invention as depicted in FIG. 13 having a base combined with an electronic device;

FIG. 17 is a schematic view of an embedded hole of the base and a magnet in a substantially inverted T-shape in accordance with the present invention; and

FIG. 18 is a schematic view of an electronic device which is an earphone with a magnet at its bottom and attracted and attached to a pair of glassed by the magnet in order to fix the earphone in accordance with an embodiment of the present invention.

### DESCRIPTION OF THE PREFERRED EMBODIMENTS

The above and other objects, features and advantages of this disclosure will become apparent from the following detailed description taken with the accompanying drawings. Exemplary embodiments are illustrated in referenced figures of the drawings. It is intended that the embodiments and figures disclosed herein are to be considered illustrative rather than restrictive.

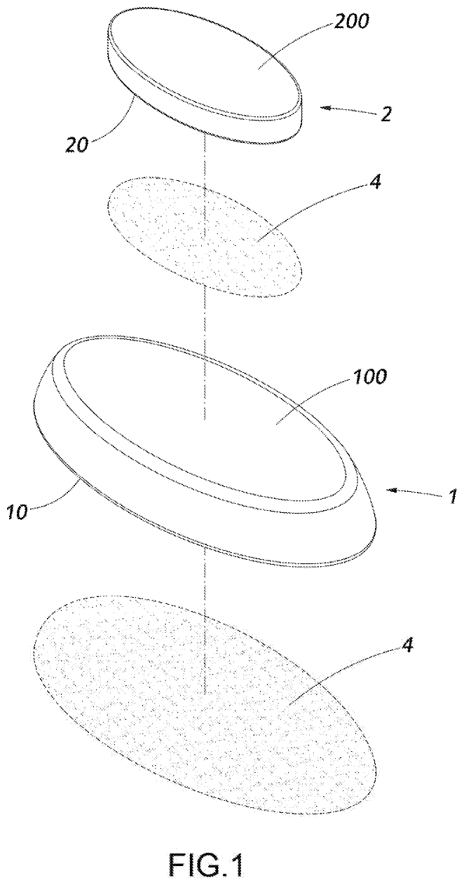

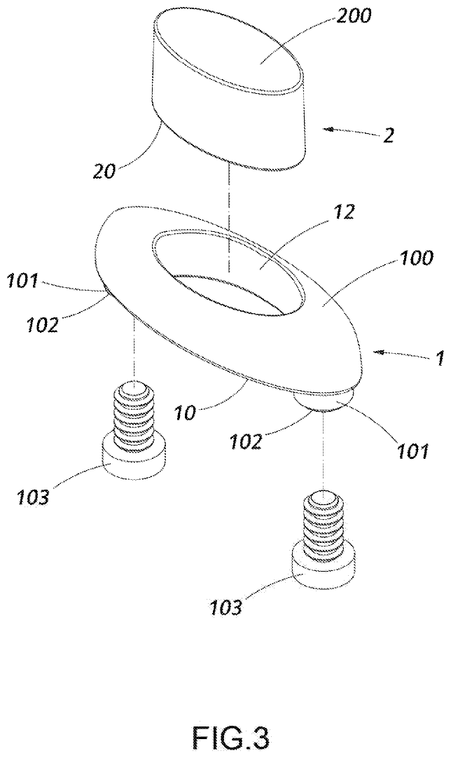

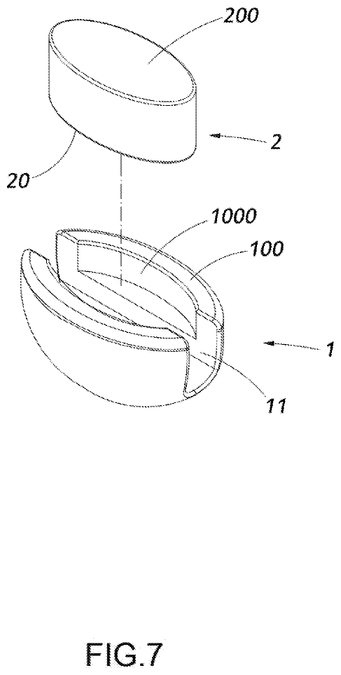

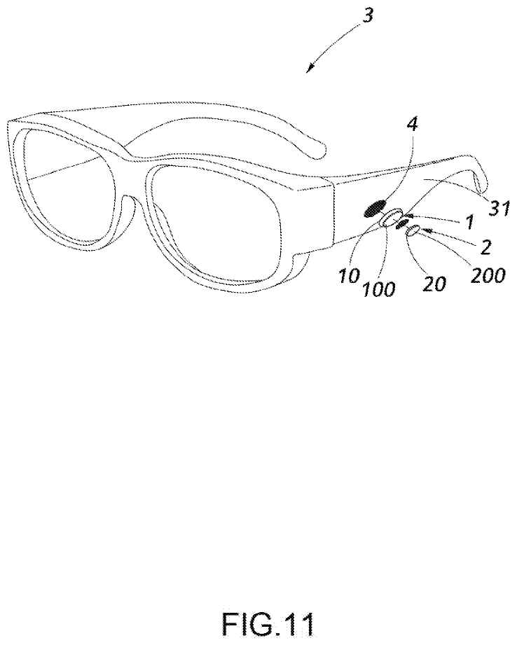

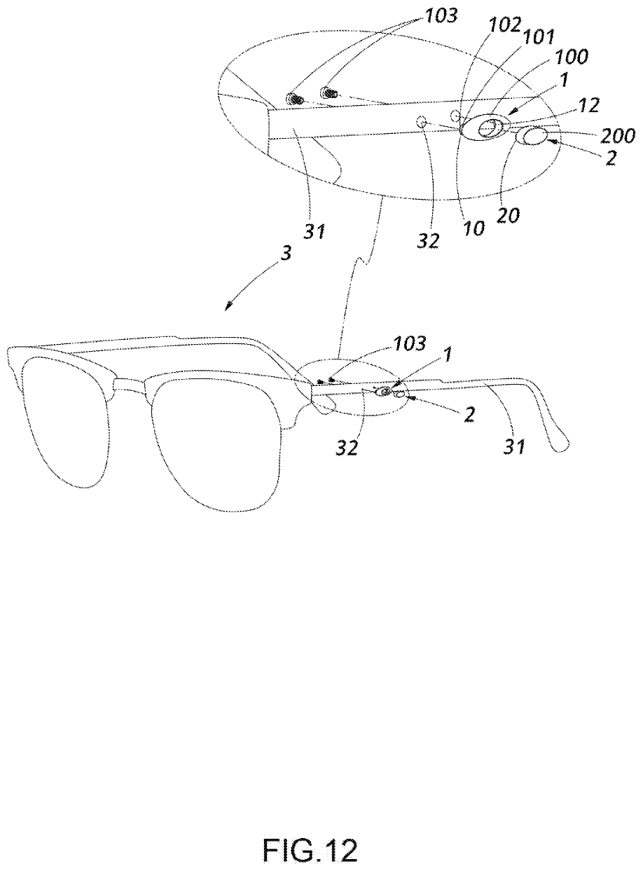

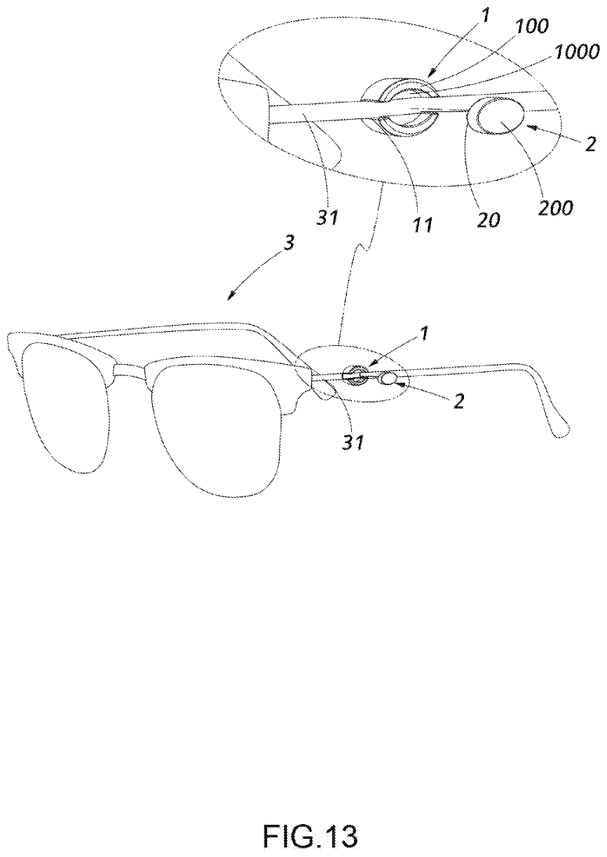

With reference to FIGS. 1˜3, 4˜5, 6˜7, 8˜9, 10˜11, 12˜14, 15˜17 and 18 for the first exploded view of the present invention, the first cross-sectional view of the present invention, and the second exploded view of another embodiment of the present invention, the second cross-sectional view of the present invention and the third exploded view of a further embodiment of the present invention, the third cross-sectional view of a further embodiment of the present invention and the fourth exploded view of another further embodiment of the present invention, the fourth cross-sectional view of another further embodiment of the present invention and the fifth exploded view of a further embodiment of the present invention, the fifth cross-sectional view of a further embodiment of the present invention and the schematic view of the present invention as depicted in FIG. 1 combined with a glasses leg of a pair of eyeglasses, the schematic view of the present invention as depicted in FIG. 3 combined with a glasses leg of a pair of eyeglasses, the schematic view of the present invention as depicted in FIG. 7 combined with a glasses leg of a pair of eyeglasses and the schematic view of the present invention as depicted in FIG. 11 having a base combined with an electronic device, the schematic view of the present invention as depicted in FIG. 12 having a base combined with an electronic device, the schematic view of the present invention as depicted in FIG. 13 having a base combined with an electronic device, and the schematic view of an embedded hole of the base and a magnet in a substantially inverted T-shape in accordance with the present invention, and the schematic view of an electronic device which is an earphone with a magnet at its bottom and attracted and attached to a pair of glassed by the magnet in order to fix the earphone in accordance with an embodiment of the present invention respectively, the connecting structure capable of connecting various eyeglasses and electronic devices is applied to a pair of eyeglasses having a glasses leg 31 or at least one through hole 32 formed on the glasses leg 31 or a pair of weldable eyeglasses 3 as disclosed in the embodiments. The connecting structure comprises a base 1 and a magnet 2.

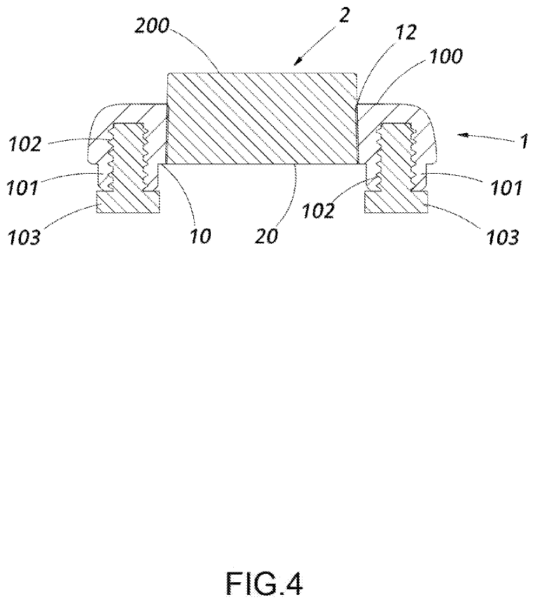

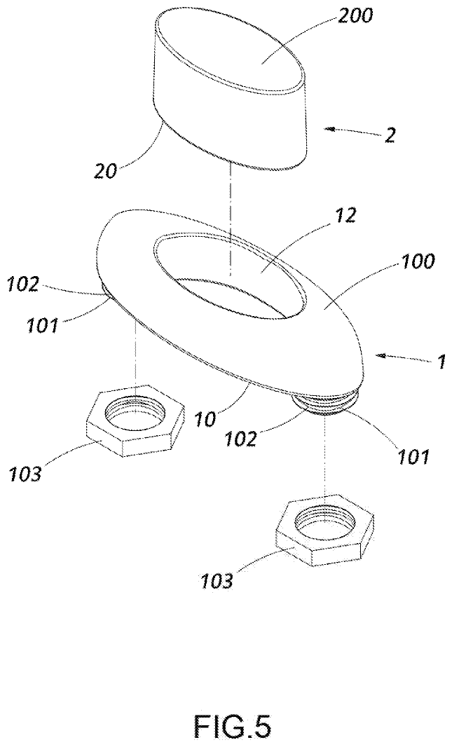

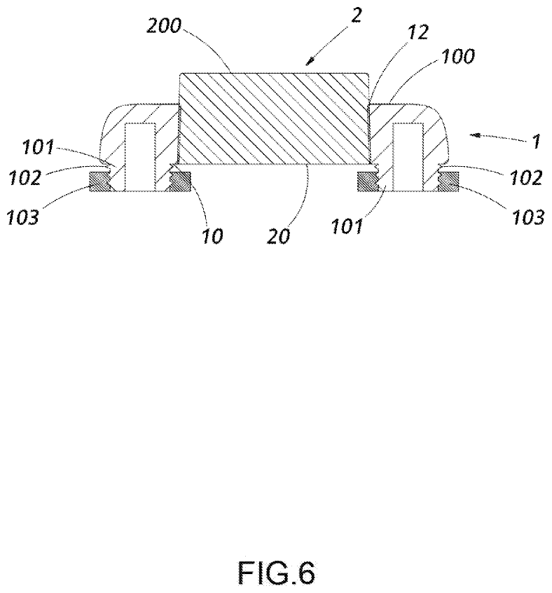

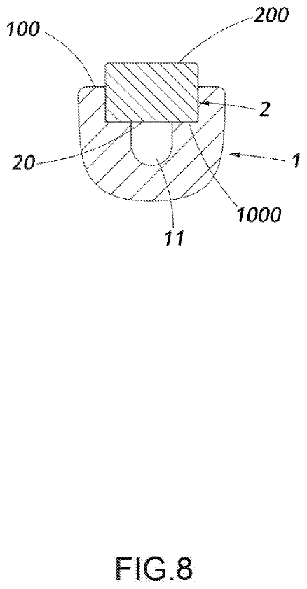

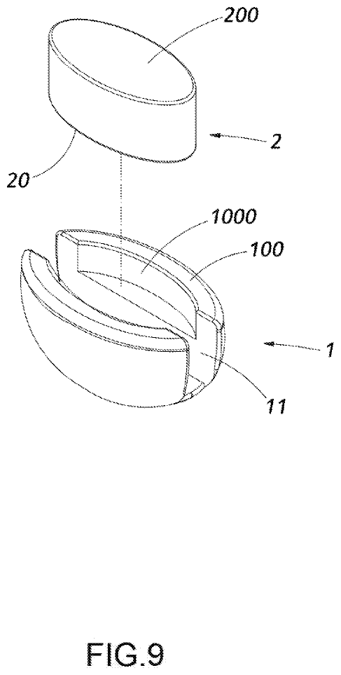

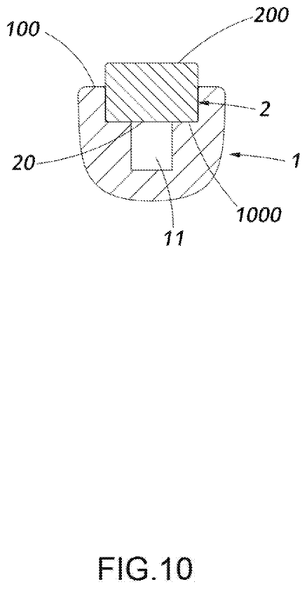

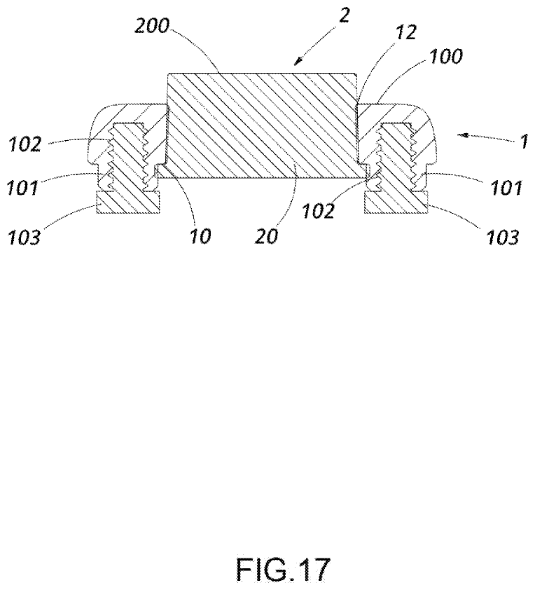

The base 1 is disposed at the glasses leg 31 of the eyeglasses 3 and has a top surface 100 and a bottom surface 10 disposed at the upper end and the lower end of the base 1 respectively, and the bottom surface 10 of the base 1 is a plane and has an adhesive 4 provided for adhering with the outer side of the glasses leg 31 (as shown in FIGS. 1, 2, and 11). The base 1 has at least one embedded hole 12 formed at the center of the base 1, and the embedded hole 12 is in an upwardly tapered conical shape (as shown in FIGS. 3 to 6) or inverted T-shape (as shown in FIG. 17), and the bottom surface 10 of the base 1 has at least one protruding column 101 adjacent to the embedded hole 12 (as shown in FIGS. 3 to 6) and configured to be corresponsive to at least one through hole 32 of the glasses leg 31, and the protruding column 101 has a fastener 103 fixed to the other side of the glasses leg 31 (as shown in FIG. 12). In addition, the protruding column 101 has a fastener 103 configured to be corresponsive to the fixing portion 102, and the fixing portion 102 is a screw hole formed at the center of the protruding column 101 (as shown in FIGS. 3 and 4), but the invention is not limited to such arrangement only, and the fixing portion 102 may be an external thread formed on an outer side of the protruding column 101 (as shown in FIGS. 5 and 6) and provided for securing the fastener 103 such as a screw or a nut with the screw hole of the protruding column 101 or the external thread of the protruding column 101 on the other side of the glasses leg 31 of the eyeglasses 3. The base 1 has a slot 11 formed at the center of the base 1 and configured to be corresponsive to the glasses leg 31 of the eyeglasses 3, and the top surface 100 of the base 1 has a recess 1000 communicating to the slot 11 (as shown in FIGS. 7 to 10 and 13), wherein the slot 11 of the base 11 may be in a circular shape (as shown in FIGS. 7 and 8) or a square shape (as shown in FIGS. 9 and 10), but the invention is not limited to these shapes only.

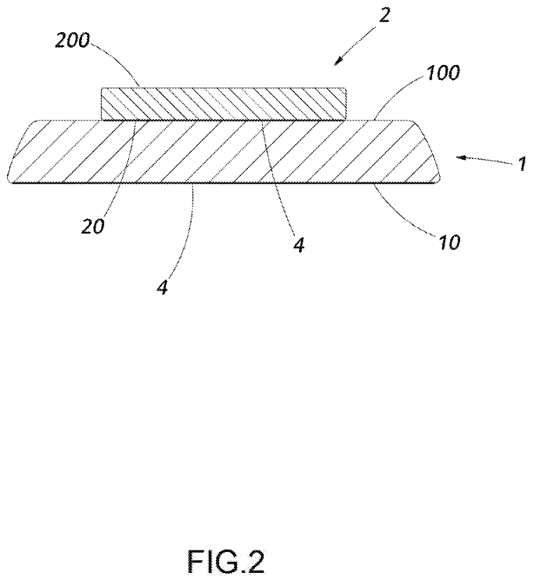

The magnet 2 is installed at the base 1 and has a top surface 200 and a bottom surface 20 disposed at the upper end and the lower end of the base 1 respectively (as shown in FIGS. 1 and 2), wherein the magnet 2 is in an upwardly tapered conical shape and has an embedded hole 12 in a shape corresponding to the upwardly tapered conical shape of the base 1 (as shown in FIGS. 3 to 6) or an inverted T-shape corresponding to the inverted T-shape of the base 1 (as shown in FIG. 17), but the invention is not limited to these shapes only. In an embodiment of a metal glasses leg 31, the metal glasses leg 31 can be combined with a magnet 2 by soldering (not shown in the figure), and the bottom surface 20 of the magnet 2 is a plane and has an adhesive 4 adhered with the top surface 100 of the base 1 (as shown in FIGS. 1 and 2), and the magnet 2 is installed in the recess 1000 of the base 1, and provided for sealing the glasses leg 31 of the eyeglasses 3 into the slot 11 of the base 1 (as shown in FIG. 13).

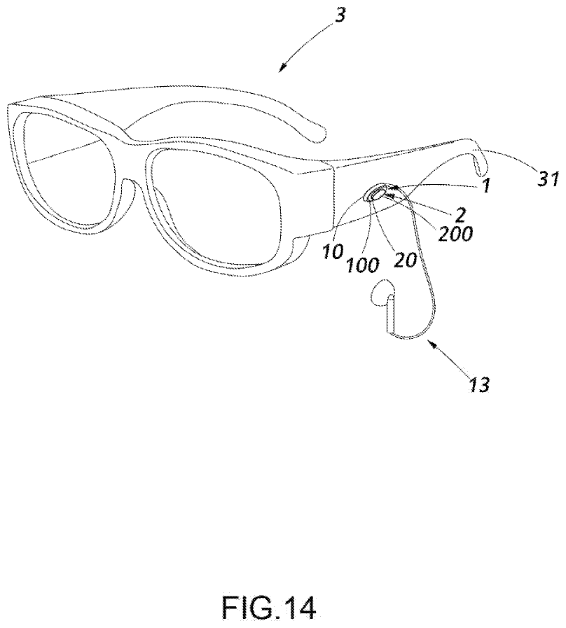

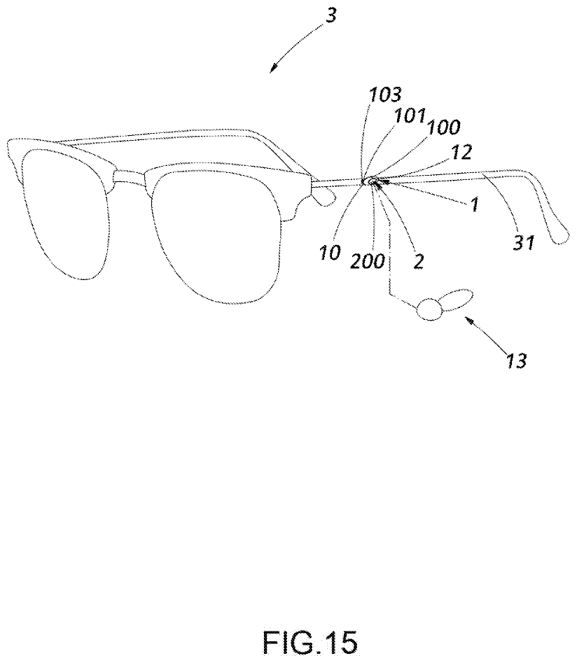

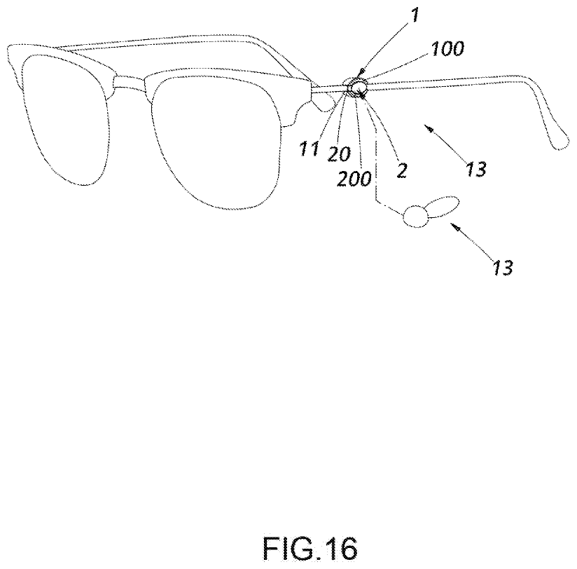

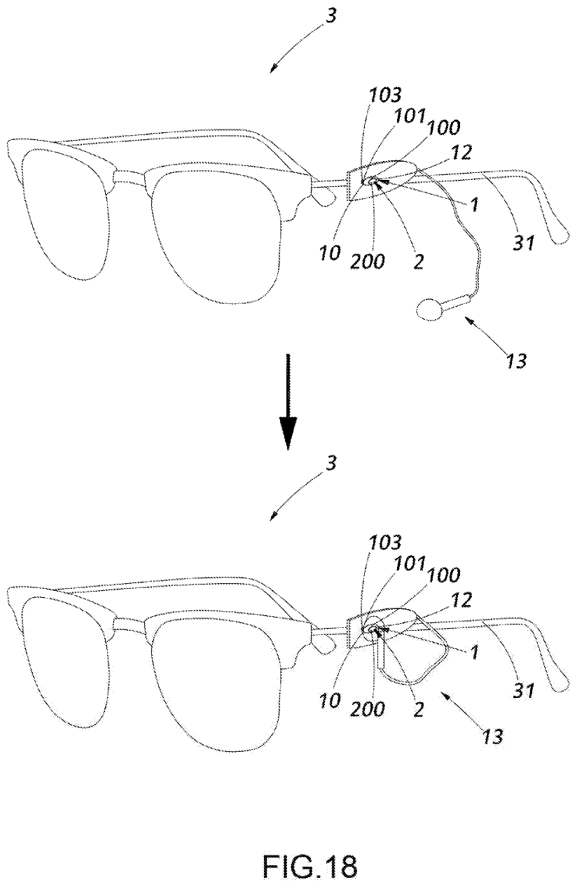

In addition, the base 1 has at least one electronic device 13 attractable by the magnet 2. In this embodiment, the electronic device 13 is an earphone (as shown in FIGS. 14 to 16), but the present invention is not limited to the earphone only, and any electronic device 13 attractable by the magnet 2 is covered by the scope of the present invention. For example, the electronic device 13 of this invention is a (Bluetooth) earphone having a magnet installed at the bottom (not shown in the figure) and provided for attracting the glasses leg 31 of the eyeglasses 3 and/or fixing the earphone by the magnetic attraction (as shown in FIG. 18).

Compared with the prior art, the present invention has the following advantages:

1. The models of the eyeglasses 3 combined with the connecting structure of the present invention are not limited. 2. The wearing comfort of the eyeglasses 3 combined with the connecting structure of the present invention will not be sacrificed. 3. The function of attaching the electronic device 13 by the magnet 2 can be extended tremendously. 4. The eyeglasses 3 still remain the original function after the connecting structure of the invention is detached from the eyeglasses 3.

In the structure of the invention, the magnet 2 installed at the base 1 of the glasses leg 31 of the eyeglasses 3 and/or the electronic device 13 connected to the base 1 are used to fix the glasses leg 31 of the eyeglasses 3, and the magnet 2 installed at the base 1 can attract any electronic device 13 attractable by the magnet 2, so that the invention can improve the convenience of use and meet with the user requirements.

In summation of the description above, the present invention breaks through the conventional structure and achieves the effect of the desired improvement. The invention cannot be conceived easily by persons having ordinary skill in the art, and it also complies with the requirements for patent application and thus is duly submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A connecting structure capable of connecting various eyeglasses and electronic devices, applied to a pair of eyeglasses having a glasses leg or at least one through hole formed on the glasses leg, or a pair of weldable eyeglasses, comprising: a base, disposed at the glasses leg of the eyeglasses, and having a top surface and a bottom surface disposed at the upper end and the lower end of the base respectively; and a magnet, installed at the base, and having a top surface and a bottom surface disposed at the upper end and the lower end of the magnet respectively.

2. The connecting structure capable of connecting various eyeglasses and electronic devices according to claim 1, wherein the bottom surface of the base is substantially a plane and has an adhesive provided for adhering with the outer side of the glasses leg.

3. The connecting structure capable of connecting various eyeglasses and electronic devices according to claim 1, wherein the base has at least one embedded hole formed at the center of the base and configured to be corresponsive to the magnet.

4. The connecting structure capable of connecting various eyeglasses and electronic devices according to claim 3, wherein the embedded hole of the base is in an upwardly tapered conical shape or inverted T-shape.

5. The connecting structure capable of connecting various eyeglasses and electronic devices according to claim 3, wherein the bottom surface of the base has at least one protruding column disposed adjacent to the embedded hole and configured to be corresponsive to at least one through hole of the glasses leg, and the protruding column has a fastener fixed to the other side of the glasses leg.

6. The connecting structure capable of connecting various eyeglasses and electronic devices according to claim 1, wherein the base has a slot formed at the center of the base and configured to be corresponsive to the glasses leg of the eyeglasses, and the top surface of the base has a recess communicating to the slot.

7. The connecting structure capable of connecting various eyeglasses and electronic devices according to claim 4, wherein the magnet is in an upwardly tapered conical shape or inverted T-shape and configured to be corresponsive to the upwardly tapered conical shape or inverted T-shape embedded hole of the base.

8. The connecting structure capable of connecting various eyeglasses and electronic devices according to claim 1, wherein the bottom surface of the magnet is a plane and has an adhesive provided for adhering with the top surface of the base.

9. The connecting structure capable of connecting various eyeglasses and electronic devices according to claim 2, wherein the bottom surface of the magnet is a plane and has an adhesive provided for adhering with the top surface of the base.

10. The connecting structure capable of connecting various eyeglasses and electronic devices according to claim 6, wherein the magnet is installed in the recess of the base and provided for sealing the glasses leg of the eyeglasses into the slot of the base.

11. The connecting structure capable of connecting various eyeglasses and electronic devices according to claim 1, wherein the base has at least one electronic device attractable by the magnet.

12. The connecting structure capable of connecting various eyeglasses and electronic devices according to claim 2, wherein the base has at least one electronic device attractable by the magnet.

13. The connecting structure capable of connecting various eyeglasses and electronic devices according to claim 3, wherein the base has at least one electronic device attractable by the magnet.

14. The connecting structure capable of connecting various eyeglasses and electronic devices according to claim 4, wherein the base has at least one electronic device attractable by the magnet.

15. The connecting structure capable of connecting various eyeglasses and electronic devices according to claim 5, wherein the base has at least one electronic device attractable by the magnet.

16. The connecting structure capable of connecting various eyeglasses and electronic devices according to claim 6, wherein the base has at least one electronic device attractable by the magnet.

17. The connecting structure capable of connecting various eyeglasses and electronic devices according to claim 7, wherein the base has at least one electronic device attractable by the magnet.

18. The connecting structure capable of connecting various eyeglasses and electronic devices according to claim 9, wherein the base has at least one electronic device attractable by the magnet.
